(19) United States
(12) Patent Application Publication
(10) Pub. No.: US 2011/0108764 A1
(43) Pub. Date: May 12, 2011

(54) Unique formula of deoxidizer and its process for penetrating print on Wood-Plastic Composite

(76) Inventors: Xiaoqiang Guo, (US); Rentian Cao, New Brunswick, NJ (US); Wenliang Guo, Tieling (CN)

(21) Appl. No.: 12/616,180

(22) Filed: Nov. 11, 2009

(51) Int. Cl. C09K 3/00

(52) U.S. Cl. 252/188.28

(57) ABSTRACT

The formula of deoxidizer and its process is to penetrate and print a designed pattern such as wood texture on the surface of Wood-Plastic Composite (WPC) product. After the penetrate printing, the precise pattern is permanently seamlessly printed and integrated with the surface of the WPC.

### FIELD OF THE INVENTION

The process is to penetrate and print a designed pattern such as wood texture on the surface of WPC product. After the penetrate printing, the precise pattern is permanently seamlessly printed and integrated with the surface of the WPC.

### BACKGROUND

The traditional way to décor WPC is to glue a layer of printed paper or plastic material to the surface. It has limitation on uneven surface and different shapes of objects; plus formaldehyde, as a component of glue and adhesive, is hazardous to human health. The renovation method, water printing, uses benzene printing film, has its own limitations too. Benzene has been linked to cancers such as leukemia, as well as conditions such as anemia. Another disadvantage of benzene printing film is it dissolves into the water too quick and it leaves only 5 seconds for the operator to finish the printing. The film is not stretchable in the water. The unique deoxidizer of the invention and its unique effect on polyvinyl alcohol film will solve all the issues mentioned above.

### SUMMARY OF THE INVENTION

The traditional methods include glue paper skin, layer of wood skin or PVC skin. The limitations are: 1) the surface has to be evenly flat. 2) Glue must be used on the product. This patent covers a new deoxidizer, and its unique process of using polyvinyl alcohol film to penetrate, print a designed pattern or wood texture on WPC, to make it look like a real, rich color wood product. The invention may replace the traditional wood fiber process of gluing a layer of paper print, a layer of plastic material or a layer of real wood to its surface.

The patent overcomes the limitations; no harmful glue is used to print a wood texture film which applies on the WPC. The unique process is to print a designed pattern or wood texture on polyvinyl alcohol film. Transform the print onto the WPC in water. The film becomes flexible, stretchable in water. The designed printing pattern becomes liquefied. But it does not break up or dissolve in water. The water carries the film, contact with the surface of WPC, penetrates the print into the surface no matter the surface is even or uneven.

### DETAILED DESCRIPTION OF THE INVENTION

The invention and its process now will be described in fully detail:

1. Mix the desired color pigments with the raw materials during the WPC manufacturing process to manufacture the initial WPC products.

2. Polish the surface of the product till the surface is as smooth as real wood board.

3. Clean and dust the products.

4. Fill up a container with water.

5. Print a designed pattern or wood texture on polyvinyl alcohol film; lay the film flat on the surface of the water. Wait until the film fully absorbs the water, degraded and separated from the membrane.

6. Spray the deoxidizer evenly on the film. The ink will be liquefied during the restore operation. The solid designed patters or wood texture printing transforms into liquid and floats on the surface of the water.

7. Hang the product from step 3 over the water.

8. Lower the product and make it contact with the film. The liquid designed pattern or wood texture will penetrate into the surface.

9. Carry the product through a shower system; wash off the residue of degraded polyvinyl alcohol membrane attachments.

10. Blow dry the product.

11. Apply a layer of water based clear paint or wood wax evenly on the surface; this will enrich the wood texture. Now the product is ready for further processing such as cut into desired shapes.

12. The unique formula of the deoxidizer is (percentage by weight):

| | |
|---|---|
| Propanol | 31.5% |
| Butyl- | 31.5% |
| DOP | 11.0% |
| Propyl | 3.0% |
| A102 Slow Dry Agent | 10.5% |
| methyl butyl ketone | 5.3% |
| GBA664 dispersant | 4.2% |
| A glycol ether | 3.0% |

13. The specified amount of the deoxidizer to spray on the polyvinyl alcohol film is 0.06-0.08kg/m². The speed to spray reducing agent on the penetration film is 1 square meter/3 seconds.

The invention is providing a process to precisely penetrate and print a designed pattern such as wood texture from a thin film to even or uneven WPC surface. Make the film more stable, stretchable in the water. Make the process easy for batch production. The patent invents an environment friendly process with zero pollution, to transform a designed pattern or wood texture on WPC products. Though the process a designed pattern or wood texture is naturally printed and penetrated into the WPC surface; never loosens, never chips off and it is water proof. The texture is equally elegant as real wood texture.

1. The unique formula of deoxidizer is (percentage by weight):

| | | |
|---|---|---|
| i. | Propanol | 31.5% |
| ii. | Butyl- | 31.5% |
| iii. | DOP | 11.0% |
| iv. | Propyl | 3.0% |
| v. | A102 Slow Dry Agent | 10.5% |
| vi. | methyl butyl ketone | 5.3% |
| vii. | GBA664 dispersant | 4.2% |
| viii. | A glycol ether | 3.0% |

The specified amount of the deoxidizer to spray on polyvinyl alcohol film is 0.06-0.08kg/m².
The specified speed to spray the deoxidizer on polyvinyl alcohol film is per square meter/3 seconds.
